(19) United States
(12) Patent Application Publication
(10) Pub. No.: US 2005/0209366 A1
(43) Pub. Date: Sep. 22, 2005

(54) Inkjet ink composition

(76) Inventor: Clarence Gaetano Hermansky, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/083,499

(22) Filed: Mar. 18, 2005

Related U.S. Application Data
(60) Provisional application No. 60/554,196, filed on Mar. 18, 2004.

(51) Int. Cl. C03C 17/00; C09D 11/00

(52) U.S. Cl. 523/160; 523/161

(57) ABSTRACT

The instant invention pertains to an inkjet ink and, more particularly, to an inkjet ink comprising a soluble colorant and a vehicle, wherein the vehicle is comprised of an aqueous continuous phase, a “microemulsified” oil phase and a block copolymer additive.

### CROSS-REFERENCE TO RELATED APPLICATIONS

This application claims priority under 35 U.S.C. §119 from U.S. Provisional Application Ser. No. 60/554,196 (filed Mar. 18, 2004), the disclosure of which is incorporated by reference herein as if fully set forth.

### BACKGROUND OF THE INVENTION

The instant invention pertains to an inkjet ink composition. More particularly, the invention pertains to an inkjet ink composition comprising a soluble colorant and a vehicle, wherein the vehicle is comprised of an aqueous continuous phase, a “microemulsified” oil phase and a block copolymer additive.

Inkjet printing is a non-impact printing process in which droplets of ink are deposited on print media, such as paper, to form the desired image. The droplets are ejected from a printhead in response to electrical signals generated by a microprocessor. Inks used in such recording are subject to rigorous demands including, for example, good dispersion stability, ejection stability, and good fixation to media.

Both dyes and pigments have been used as colorants for inkjet inks. Pigments can provide excellent durability with regard to fade resistance (light fastness) and good chroma when formulated properly. Dyes provide good chroma and are considered easier to formulate, but are less lightfast.

Dye-based inks may suffer from other deficiencies, for example, images printed with dye inks tend to lack water fastness, and suffer from bleed and feathering. Solutions to these problems often cause other problems, for example, applying a fixer to increase water fastness tends to reduce chroma.

The background of U.S. Pat. No. 6,261,350 provides a good discussion of dye ink formulation and problems. Art related to improved dye formulations includes the following references.

U.S. Pat. No. 4,783,220 pertains to ink comprising oil-soluble dye in association with surfactant vesicles. Disclosed is an oil-soluble dye associated with (cationic) dioctadecyldimethyl ammonium bromide vesicles.

U.S. Pat. No. 5,116,409 pertains to an aqueous ink composition comprising water-soluble anionic dyes and certain surfactants. Disclosed is an aqueous ink with an anionic dye and cetyl trimethylammonium bromide (CTAB) as surfactant.

U.S. Pat. No. 5,565,022 pertains to an aqueous ink composition comprising water, dye, oil and an amphiphile to solubilized the oil. Disclosed is a composition comprising water, an anionic water soluble dye, ethylene glycol phenyl ether (oil) and sodium xylene sulfonate amphihile.

U.S. Pat. No. 6,001,899 pertains to an aqueous ink composition comprising water, an anionic dye and a polyquarternary amine compound. Disclosed are compositions comprising water and a polyquarternary amine compound selected from the group consisting of polydiallyl ammonium compounds, polyquaternized polyvinylamines, polyquaternized polyallylamines and mixtures thereof.

U.S. Pat. No. 6,054,505 pertains to an aqueous ink composition comprising water, a non-polymeric salt comprising at least one cation and at least one anion, and a colorant comprising an anionic dye complexed with a polyquaternary amine compound.

Commonly owned U.S. application Ser. No. 10/939,664 (filed Sep. 13, 2004), entitled “Inkjet Ink Composition,” discloses an inkjet ink composition comprising:
(1) a vehicle comprising:
   (a) an aqueous continuous phase,
   (b) an oil phase emulsified in said aqueous continuous phase, and
   (c) an ionic groups-containing emulsifier to stabilize the emulsion of said oil phase in said aqueous phase, said ionic groups of said emulsifier having a first charge; and
(2) a colorant soluble in said aqueous continuous phase and having, in solution, a second charge such that said second charge is opposite in sign to said first charge.

All of the disclosures of the above-identified publications/references are incorporated by reference herein for all purposes as if fully set forth.

There is still a need for dye based ink compositions with improved water fastness and high chroma.

### SUMMARY OF THE INVENTION

The present invention pertains to an inkjet ink composition comprising a vehicle and at least one soluble, ionizable colorant, and further comprising a block copolymer additive.

The vehicle comprises an aqueous phase and a water-insoluble oil phase wherein the oil phase is emulsified in the aqueous (continuous) phase to form an isotropic liquid. The oil phase is stabilized to emulsion by one or more emulsifiers, and at least one of the emulsifiers is ionizable. The charge on the ionizable colorant and the ionizable emulsifier are opposite in sign.

The block copolymer is an additive to the ink composition, and is comprised of at least one a hydrophobic segment and at least one hydrophilic segment such that, when added to the vehicle, it is stably dispersed or dissolved therein. The at least one hydrophilic segment comprises one or more ionic groups, the charge of which is the same in sign as the charge of the emulsifier, and opposite in sign to the ionizable colorant. Thus, when the ionizable colorant is anionic, the ionizable emulsifier and block copolymer are cationic; and, when the ionizable colorant is cationic, the ionizable emulsifier and copolymer are anionic.

Accordingly, there is provided an inkjet ink composition comprising:
(1) a vehicle comprising:
   (a) an aqueous continuous phase,
   (b) an oil phase emulsified in said aqueous continuous phase, and
   (c) an ionic group-containing emulsifier to stabilize the emulsion of said oil phase in said aqueous phase, said ionic groups of said emulsifier having a first charge,
(2) a colorant soluble in said aqueous continuous phase and having a second charge such that said second charge is opposite in sign to said first charge; and
(3) a block copolymer additive stably dispersed or dissolved in the vehicle, the block copolymer additive having a hydrophobic segment and a hydrophilic segment, the hydrophilic segment having one or more ionic groups the charge of which is the same in sign as the first charge.

Preferably, the colorant is soluble in the aqueous phase and substantially insoluble in the oil phase.

In accordance with another aspect of the present invention, there is provided an ink set comprising at least three differently colored inks, wherein at least one of the inks is an inkjet ink as set forth above.

In another aspect of the present invention, there is provided a method for ink jet printing onto a substrate, comprising the steps of:
(a) providing an ink jet printer that is responsive to digital data signals;
(b) loading the printer with a substrate to be printed;
(c) loading the printer with an ink as set forth above and described in further detail below, or an ink jet ink set as set forth above and described in further detail below; and
(d) printing onto the substrate using the ink or inkjet ink set in response to the digital data signals.

Preferred substrates include plain paper and textiles.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

The instant inks comprise a vehicle, a colorant and a block copolymer additive.

The vehicle is an isotropic liquid mixture of an aqueous phase and an oil phase. It is believed the mixture is in the form of a microemulsion, and will be referred to as such, but the precise structure of the vehicle is not limiting so long as it is an isotropic mixture. There are one or more emulsifiers to stabilize the oil phase as a microemulsion. Stabilization of the microemulsion can be assisted with one or more optional co-emulsifiers.

The colorant, a dye, is soluble in the aqueous phase of the vehicle; it is, typically, substantially insoluble in the oil phase.

The block copolymer additive is stably dispersed or dissolved in the vehicle.

The inks can also contain other ingredients as are well known in the art. Adaptation of the ink formulation to a particular inkjet printer may be needed to provide an appropriate balance of properties such as, for instance, viscosity and surface tension.

Colorant

The colorant is a dye that is soluble in the aqueous phase and is ionizable. Ionizable dyes are those dyes that, in aqueous solution, yield colored ions: anionic dyes yield colored anions and cationic dyes yield colored cations. Such dyes are well known to those of ordinary skill in the art.

Anionic dyes typically contain carboxylic and/or sulfonic acid groups as the ionic moiety. The types of anionic dyes most useful in this invention are, for example, Acid, Direct, Food, Mordant and reactive dyes.

Anionic dyes are preferably selected from the group consisting of nitroso compounds, nitro compounds, azo compounds, stilbene compounds, triarylmethane compounds, xanthene compounds, quinoline compounds, thiazole compounds, aminoketone compounds, anthraquinone compounds, indigoid compounds, phthalocyanine compounds and mixtures thereof. Preferred anionic dyes that may suitably be employed in the practice of the invention include, but are not limited to: C. I. Acid Blue 9, C. I. Acid Blue 40, C. I. Acid Red 18, C. I. Acid Red 52, C. I. Acid Yellow 23, C. I. Direct Blue 199, C. I. Mordant Violet 5, C. I. Mordant Violet 39, and their counterions include, e.g., Na⁺, Li⁺, Cs⁺, NH₄⁺ and substituted ammonium salts.

Preferred types of cationic dyes include mainly the basic dyes and some of the mordant dyes that are designed to bind to acidic sites on a substrate, such as fibers. Preferred types of such dyes include the azo compounds, diphenylmethane compounds, triarylmethanes, xanthene compounds, acridiline compounds, quinoline compounds, methine or polymethine compounds, thiazole compounds, indamine or indophenyl compounds, azine compounds, oxazine compounds and thiazine compounds, among others, and mixtures thereof, all of which are known in the art.

Preferred cationic dyes that may suitably be employed in the practice of this invention include, but are not limited to: C. I. Basic Blue 3, C. I. Basic Blue 9, C. I. Basic Red 1, C. I. Basic Red 3, C. I. Basic Violet 7, C. I. Basic 10, C. I. Basic Violet 16, C. I. Basic Violet 23, C. I. Basic Yellow 9, C. I. Basic 11, C. I. Mordant Blue 14 and C. I. Mordant Green 13, and their counterions include, e.g., Cl⁻, Br⁻, ZnCl₄⁻ and NO₃⁻.

The color and amount of ionic dye used in the ink composition is largely a function of choice, being primarily dependent upon the desired color of the print achieved with the ink, the purity of the dye and its strength. Low concentrations of dye may not give adequate color vividness. High concentrations may result in poor printhead performance or unacceptably dark colors.

The ionizable dye is typically present in the amount of about 0.01% to about 12% by weight, preferably about 0.05% to about 10% by weight, and more preferably about 1% to about 8% by weight, based on the total weight of the ink. The dye can be a mixture of two or more dyes.

Aqueous Phase

“Aqueous phase” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (the disclosure of which is incorporated by reference herein for all purposes as if fully set forth).

If a mixture of water and a water-soluble solvent is used, the aqueous phase typically will contain about 30% to about 95% water with the balance (i.e., about 70% to about 5%) being the water-soluble solvent. Preferred compositions contain about 60% to about 95% water, based on the total weight of the aqueous phase. The amount of aqueous phase in the ink is typically in the range of about 50% to about 98%, based on total weight of the ink.

The vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol.

The amount of glycol ether(s) and 1,2-alkanediol(s) added must be properly determined, but is typically in the range of from about 1 to about 15% by weight and more typically about 2 to about 10% by weight, based on the total weight of the ink.

Oil Phase

The “oil phase” refers to a water-insoluble organic solvent. Examples of water-insoluble organic compounds (“oils”) include, but are not limited to, water-insoluble members of the following classes of materials: ethyleneoxy- and propyleneoxy-oils; mono- or polyglycol ethers; alcohols; polyols; water-insoluble mono- or polyglycol esters; terpenes; phenols; aldehydes; ketones; hydrocarbons; polyether modified polysiloxanes; and mixtures thereof. In general, any water-insoluble organic compound, or combination thereof, may be employed in the practice of the invention, as long as it is compatible with the other components in the inkjet ink composition. Preferred oils include mono- and diethylene glycol phenyl ether, and mono- and dipropylene glycol phenyl ether.

Selecting oils with a vapor pressure less than that of water can be advantageous in retarding evaporation of the ink and preventing pluggage of the inkjet nozzles. Also, incorporating oil in the ink vehicle reduces paper cockle compared to an entirely aqueous vehicle.

The amount of the oil phase is varied as needed but is typically in the range of from about 1% to about 40%, and more typically from about 2 to about 20%, by weight based on the total weight of ink.

Emulsifier

Emulsifiers are surfactants, but the use of the term “emulsifier” herein will be restricted to mean surfactants specifically employed to effect the microemulsification of the oil. Like any surfactant, emulsifiers consist of a water-soluble (hydrophilic) segment and an oil-soluble (lipophilic) segment. The hydrophilic segment, in general, can be non-ionic or ionic (ionizable). As prescribed by the present invention, there is at least one ionizable emulsifier present in the formulation, although there can be more than one emulsifier and the additional emulsifier(s) can include one or more non-ionic emulsifiers.

Ionizable groups in the hydrophilic segment yielding anions (anionic emulsifiers) include: carboxylate, sulfate, sulfonate, and phosphate and phosphonates. Examples of anionic surfactants include, but are not limited to: alkylbenzene sulfonates, alkyl sulfonate, alkylsulfate, sulfosuccinates, alcohol ethoxylate sulfate, alcohol ethoxylate sulfonate, alkyl phosphate, alkylethoxylated phosphate, ethoxylated alkylphenol sulfate, fatty carboxylate, taurate, isethionate, aliphatic carboxylate, or those derived from a polymer containing an acid group. Preferred examples include sodium dodecylbenzene sulfonate, sodium dodecylsulfate, and block copolymers of (meth)acrylic acid and their salts.

Ionizable groups in the hydrophilic segment yielding cations (cationic emulsifiers) include ammonium and quaternary ammonium. Ammonium derivatives include the protonated form of fatty amines, esters of an aminoalcohol, alkylamines, polymers containing an amine functionality, aniline and its derivatives, fatty alcohol esters of amino acids, polyamine N-alkylated with a dialkyl succinate ester, heterocyclic amines, quanidine derivative of fatty amines, guanidine derivative of alkylamines, guanidine derivatives of arylamines, amidine derivatives of fatty amines, amidine derivative of fatty acids, amidine derivatives of alkylamines, or amidine derivatives of arylamines. Quaternary ammonium derivatives include but are not limited to fatty alkyl trimethyl ammonium, and alkyl trimethyl ammonium or 1-alkylpyridinium salts, where the counter ion is halide, sulfonate, sulfate or the like. A preferred class of quaternary emulsifier is represented by the following structure:
[R(CH₃)₃N]+X⁻
wherein R is a C₆-C₃₀ alkyl, and X is an anionic counterion such as halide, sulfonate, sulfate and the like.

A particularly preferred example is the quaternary cationic emulsifier cetyltrimethyl ammonium bromide.

The selection of a particular emulsifier, and the level employed, depends on the oil, as is in general well known. Typically, emulsifier levels are from about 1% to about 20% by weight based on the total weight of the ink composition.

Co-Emulsifier

Microemulsions are often more effectively stabilized with the aid of what is commonly referred to as a “co-surfactant”. For consistency with the terminology used herein, these species will be referred to as “co-emulsifiers”.

Co-emulsifiers are typically (C₃-C₈) alcohols, especially linear alcohols. Particularly preferred are n-butanol, n-pentanol, n-hexanol and 2-pentanol. When present, coemulsifiers comprise about 0.1% to about 20%, preferably about 0.1% to about 15%, and more preferably from about 0.1% to about 10%, by weight based on the total weight of the ink composition.

A molar ratio of surfactant (emulsifier) to co-surfactant (co-emulsifier) of about 1:8 or less, and preferably about 1:5, is preferred from the standpoint of providing a phase map with the largest microemulsion region.

Block Copolymer Additives

The block copolymer additives are polymers comprised of at least one hydrophobic segment (“A” block) and at least one hydrophilic segment (“B” block). The at least one hydrophilic segment comprises ionizable moieties which impart charge to the polymer.

The block copolymer is typically an AB block copolymer wherein there is just one hydrophobic segment and just one hydrophilic segment. Such block copolymers are described in, for example, in US5085698, the disclosure of which is incorporated by reference herein for all purposes as if fully set forth.

The A segment can, for example, be a hydrophobic homopolymer or copolymer of an acrylic monomer having the formula
CH₂═C(X)(Y)
wherein X is H or CH₃ and Y is C(O)OR₁, C(O)NR₂R₃ or CN, wherein R₁ is an alkyl, aryl or alkylaryl group having 1 to 20 carbon atoms, and R₂ and R₃ are hydrogen or an alkyl, aryl or alkylaryl group having 1 to 9 carbon atoms; the A segment having an average molecular weight of at least approximately 300 and being water insoluble.

The B segment can, for example, be a hydrophilic polymer or copolymer, or salt thereof, or an acrylic monomer having the formula
CH₂═C(X)(Y′)
wherein X is H or CH₃, and Y′ is C(O)OH, C(O)NR₂R₃, or C(O)OR₄NR₂R₃; wherein R₂ and R₃ are hydrogen or an alkyl, aryl, or alkylaryl group having 1 to 9 carbon atoms, and R₄ is an alkyl diradical having 1 to 5 carbon atoms; the B segment having an average molecular weight of at least approximately 300 and being water soluble. Representative monomers include methacrylic acid (MAA), acrylic acid, dimethylaminoethyl methacrylate (DMAEMA).

The B block generally will constitute about 10% to about 90%, and more preferably about 25 to about 65%, by weight based on the weight of the block copolymer.

The ratio of block copolymer to colorant (dye) is determined stoichiometrically, as the molar ratio of ionic copolymer groups to ionic dye functional groups, with a preferred ratio of about 0.1 to about 1.5, and more preferably about 0.5 to about 1.0.

Other Ingredients

Consistent with the requirements for the inks of this invention, various types of additives may be employed in the ink to optimize the properties of the ink composition for specific applications. For example, as is well known to those skilled in the art, one of more biocides, fungicides, and/or microbial agents may be used. Examples of suitable employed microbial agents include, but are not limited to, NUOSEPT (Nudex, Inc.), UCARCIDE (Union Carbide), VANCIDE (R. T. Vanderbilt Co.), and PROXEL (ICI America). Additionally, sequestering agents such as EDTA may be included to eliminate deleterious effects of heavy metal impurities, and buffer solutions may be used to control the pH of the ink. Other known additives such as viscosity modifiers and other acrylic or non-acrylic polymers may be added to improve various properties of the ink compositions as desired.

Ink Preparation

The ink compositions of the present invention will generally be prepared by adding colorant, block copolymer and other optional additives to a preformed vehicle microemulsion. The microemulsion vehicle will have been optimized separately, prior to making the final ink.

Techniques for scouting microemulsions are known. For example, the oil, co-emulsifier and water can be combined in a ratio that reflects the final desired inkjet ink composition. This two-phase mixture can then be titrated with the emulsifier until a single-phase is obtained. When optimized, the dye, and any desired additives, can be added to this single-phase vehicle to complete the formulation of the ink.

Often, a more systematic approach to preparing scouting microemulsions is desired. In that case, a ternary phase map can be constructed by fixing the ratio of any two components. For example, the ratio of the emulsifier to co-emulsifier (E/C) can be fixed, leaving the three apices (“corners”) of the phase map to represent oil, water and E/C. For each E/C ratio, a phase map is constructed by titrating various proportions of oil and E/C mixture with water, noting the visual characteristics of the mixture corresponding to each water addition. Depending on the composition, multi-phase, semi-solid, and clear, single-phase regions will be found. When plotted on a conventional phase diagram, single-phase regions suitable for use in an inkjet ink can be identified.

The addition of the ionic dye or block copolymer to a preformed microemulsion vehicle may cause destabilization (phase separation) of the microemulsion. In most cases, where the ionic dye causes destabilizing, adding more emulsifier will offset the destabilization, reforming the microemulsion. Where the block copolymer causes destabilizing, a reduction in the amount of copolymer and/or emulsifier has been seen to improve stability.

Ink Properties

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C. (30 cP or less), but is typically somewhat lower. The ink has physical properties adjusted to the ejecting conditions and printhead design. The inks should have excellent storage stability for long periods so as to avoid clogging to any significant extent an ink jet apparatus. Further, the ink should not corrode parts of the inkjet-printing device it comes in contact with, and it should be essentially odorless and non-toxic.

The ink set of this invention can be particularly advantageous for applications where low viscosity is required. Thus the viscosity (at 25° C.) of the inventive inks can be less than about 7 cps, or less than about 5 cps, and even less than about 3.5 cps.

Ink Sets

In accordance with another aspect of the present invention, there is provided an ink set comprising an inkjet ink as described above. This ink set more preferably comprises at least three differently colored inks (such as CMY), and more preferably at least four differently colored inks (such as CMYK), wherein at least one of the inks is an ink as described above.

The other inks of the ink set are preferably aqueous inks, and may contain dyes, pigments or combinations thereof as the colorant. Such other aqueous inks are based on aqueous vehicles and other components and additives as described above or as otherwise are known to those of ordinary skill in the art and may, in a general sense, be considered known to those of ordinary skill in the art.

The ink sets more preferably comprise at least three primary inks: at least one cyan ink, at least one magenta ink and at least one yellow ink. Each of these primary inks is in turn comprised of a vehicle and an appropriate colorant dispersed (pigment) and/or dissolved (dye) in the vehicle, with at least one of the inks being an ink as described above.

The ink set may optionally include a black ink, preferably comprising carbon black pigment. When present, the carbon black pigment is preferably a “self-dispersing” carbon black such as those disclosed, for example, in U.S. Pat. No. 5,554,739, U.S. Pat. No. 5,571,311, U.S. Pat. No. 5,609,671, U.S. Pat. No. 5,672,198, U.S. Pat. No. 5,698,016, U.S. Pat. No. 5,707,432, U.S. Pat. No. 5,718,746, U.S. Pat. No. 5,747,562, U.S. Pat. No. 5,749,950, U.S. Pat. No. 5,803,959, U.S. Pat. No. 5,837,045, U.S. Pat. No. 5,846,307, U.S. Pat. No. 5,851,280, U.S. Pat. No. 5,861,447, U.S. Pat. No. 5,885,335, U.S. Pat. No. 5,895,522, U.S. Pat. No. 5,922,118, U.S. Pat. No. 5,928,419, U.S. Pat. No. 5,976,233, U.S. Pat. No. 6,057,384, U.S. Pat. No. 6,099,632, U.S. Pat. No. 6,123,759, U.S. Pat. No. 6,153,001, U.S. Pat. No. 6,221,141, U.S. Pat. No. 6,221,142, U.S. Pat. No. 6,221,143, U.S. Pat. No. 6,277,183, U.S. Pat. No. 6,281,267, U.S. Pat. No. 6,329,446, U.S. Pat. No. 6,332,919, U.S. Pat. No. 6,375,317, U.S. No. 2001/0035110, EP-A-1086997, EP-A-1114851, EP-A-1158030, EP-A-1167471, EP-A-1122286, WO01/10963, WO01/25340 and WO01/94476 (the disclosures of which are incorporated by reference herein for all purposes as if fully set forth).

The black colorant may also be dye as, for example, the black dye disclosed in U.S. Pat. No. 5,753,016. The black colorant may also be a combination of dye and pigment as, for example, disclosed in U.S. Pat. No. 6,277,184. The disclosures of both of the preceding references are incorporated by reference herein for all purposes as if fully set forth.

Methods of Printing

The inks and ink sets of the present invention can be utilized by printing with any inkjet printer.

The substrate can be any suitable substrate including plain paper, treated paper, textile, and non-porous substrates including polymeric films such as polyvinyl chloride and polyester. Preferred substrates include plain paper and textiles.

### EXAMPLES

The following copolymers were used in the preparation of the present inventive inks, wherein the hydrophobic A segment was benzyl methacrylate (BzMA) and the hydrophilic B segment was dimethyl aminoethyl methacrylate (DMAEMA).

Polymers 1 and 2, block copolymers, were made according to methods described in U.S. Pat. No. 4,508,800 (the disclosure of which is incorporated by reference herein for all purposes as if fully set forth). Polymer 3, a random copolymer, was made according to standard polymerization techniques.

Polymer 1 was a BzMA//DMAEMA 10//20 block copolymer, where 20 mole percent of the DMAEMA was quaternarized by benzyl chloride (Mn=4845). It was used as an aqueous solution with 70.6 wt % polymer solids.

Polymer 2 was a BzMA//DMAEMA, 10//20 block copolymer (Mn=4394). The co-polymer was diluted for use with tetrahydrofuran (THF) to 62.4 wt % polymer solids.

Polymer 3 was a BzMA/DMAEMA, 10/20 random copolymer, where 90 mole percent of DMAEMA was quaternarized by benzyl chloride (Mn=3847). It was used as an aqueous solution with 21.1 wt % polymer solids.

A set of inks was prepared according to the following formulations. The ingredient values are given in weight percent of the final ink. The water used was deionized water. The vehicle components were mixed together first, then the dye was added to the vehicle. Each ink was printed and evaluated for chroma and water fastness.

An Epson 3000 printer was used to print each ink in a 1×6 inch rectangle on Boise Cascade X-9000 plain paper, at 720 dpi resolution and 100% coverage. The rectangular patterns were created in CorelDraw (Corel Corporation).

Water fastness was tested by running a 2 mL stream of distilled water from a pipette across each 1×6 inch rectangular print. The prints were hung vertically to dry, then the chroma of the wetted and non-wetted areas of each print were measured with a Minolta CM-3600 spectrophotometer (Minolta Corp., USA). Better water fastness is indicated by less chroma loss.

| | Ink 1 | | | Ink 4 |
|---|---|---|---|---|
| Ingredients | (comparative) | Ink 2 | Ink 2 | (comparative) |
| Acid Blue 9 | 2.00 | 2.00 | 2.00 | 2.00 |
| Cetyl trimethyl | 6.64 | 6.42 | 6.40 | 6.38 |
| ammonium | | | | |
| bromide (CTAB) | | | | |
| n-butanol | 6.64 | 6.42 | 6.40 | 6.38 |
| Dowanol ® PPH | 3.32 | 3.20 | 3.20 | 3.20 |
| Polymer 1 (as % solids) | | 1.36 | | |
| Polymer 2 (as % solids) | | | 0.57 | |
| Polymer 3 (as % solids) | | | | 1.18 |
| HCl (1 Molar) | 0.24 | 8.49 | 5.75 | 3.56 |
| Water (balance to 100%) | Bal | Bal | Bal | Bal |
| Properties | | | | |
| pH | 4.3 | 2.4 | 2.5 | 2.5 |
| Physical Stability | stable | stable | stable | stable |
| Chroma (C*) | 31.5 | 41.5 | 37.0 | 44.2 |
| Chroma (C*) lost | 22.8 | 8.8 | 4.4 | 16.1 |
| after water treatment. | | | | |

Each ink was visually examined after 24 hours and again after one week of aging at ambient temperature. All were physically stable, homogeneous, and showed no particulate deposits.

The comparative ink (Ink 1) without any copolymer additive, had the lowest chroma value. Chroma was significantly increased when copolymer additives were included.

Water fastness was superior for the inks containing copolymer, relative to the comparative microemulsion ink (Ink 1) without added copolymer. Furthermore, the AB block copolymers of inventive Inks 2 and 3 were found to give superior waterfastness in comparison to the random copolymer in comparative Ink 4.

Three comparative inks, A-C, were prepared according to the formulations given below. All of these inks contain anionic dye and employ a typical aqueous vehicle (no microemulsion).

| Ingredients | Ink A | Ink B | Ink C |
|---|---|---|---|
| Acid Blue 9 | 2.4 | 2.4 | 2.4 |
| Glycerol | 2.6 | 2.6 | 2.6 |
| 2-Pyrolidinone | 2.0 | 2.0 | 2.0 |
| Glycereth-26 | 1.8 | 1.8 | 1.8 |
| Polymer 1 (as % solids) | | 0.2 | |
| Polymer 2 (as % solids) | | | 0.3 |
| 20% HCl | 0.2 | 0.2 | 0.2 |
| Water | 91.0 | 90.8 | 90.7 |
| Ink Properties | | | |
| pH (prior to HCl Addition) | 5.8 | 8.4 | 2.3 |
| pH (after HCl Addition) | 1.7 | 2.1 | — |

Each ink was visually evaluated at two pH levels: 1) the pH resulting from the mixture of all ingredients except 20% HCl, and 2) the pH after the addition of the indicated amount of 20% HCl. Evaluations were done 24 hours after equilibration at ambient conditions.

Ink A, without any polymer added, formed a stable ink with low viscosity.

Inks B-C, with polymer added, were unstable and formed particulate deposits. Ink A could be jetted from an inkjet pen, while Inks B-C could not.

While not being bound to any theory, it is believed that the microstructure of the oil-in-water microemulsion provides microdomains that solubilize and stabilize any complexation that may occur between oppositely charged species present in the microemulsion ink.

1. An inkjet ink composition comprising:
(1) a vehicle comprising:
(a) an aqueous continuous phase,
(b) an oil phase emulsified in said aqueous continuous phase, and
(d) an ionic group-containing emulsifier to stabilize the emulsion of said oil phase in said aqueous phase, said ionic groups of said emulsifier having a first charge,
(2) a colorant soluble in said aqueous continuous phase and having a second charge such that said second charge is opposite in sign to said first charge; and
(3) a block copolymer additive stably dispersed or dissolved in the vehicle, the block copolymer additive having a hydrophobic segment and a hydrophilic segment, the hydrophilic segment having one or more ionic groups the charge of which is the same in sign as the first charge.

2. The inkjet ink composition of claim 1, wherein the oil phase comprises an oil with a vapor pressure less than that of water.

3. The inkjet ink composition of claim 2, wherein the oil is selected from the group consisting of monoethylene glycol phenyl ether, diethylene glycol phenyl ether, monopropylene glycol phenyl ether, dipropylene glycol phenyl ether and mixtures thereof.

4. The inkjet ink composition of claim 1, wherein the oil phase is present in a range of from about 1% to about 40% by weight based on the total weight of the ink composition.

5. The inkjet ink composition of claim 1, wherein the vehicle further comprises a co-emulsifier selected from C₃-C₈ alcohols.

6. The inkjet ink composition of claim 5, wherein the co-emulsifier is present in an amount of from about 0.1% to about 20% by weight based on the total weight of the ink composition, and the molar ratio of emulsifier to co-emulsifier is about 1:8 or less.

7. The inkjet ink composition of claim 1, wherein the colorant is an anionic dye, and the emulsifier and block copolymer are cationic.

8. The inkjet ink composition of claim 1, wherein the emulsifier has the formula
[R(CH₃)₃N]⁺X⁻
wherein R is a C₆-C₃₀ alkyl, and X is an anionic counterion.

9. The inkjet ink composition of claim 1, wherein the block copolymer is an AB block copolymer comprising one hydrophobic segment and one hydrophilic segment.

10. The inkjet ink composition of claim 1, wherein the hydrophilic segment of the block coplymer comprises about 10% to about 90% by weight based on the weight of the block copolymer.

11. The inkjet ink composition of claim 1, wherein the molar ratio of ionic groups in the block copolymer to ionic groups in the colorant is in the range of from about 0.1 to about 1.5.

12. The inkjet ink composition of claim 1, having a surface tension in the range of about 20 dyne/cm to about 70 dyne/cm, and a viscosity of 30 cP or less, at 25° C.

13. An ink set comprising at least three differently colored inks, wherein at least one of the inks is a first inkjet ink composition comprising:
(1) a vehicle comprising:
(a) an aqueous continuous phase,
(b) an oil phase emulsified in said aqueous continuous phase, and
(e) an ionic group-containing emulsifier to stabilize the emulsion of said oil phase in said aqueous phase, said ionic groups of said emulsifier having a first charge,
(2) a colorant soluble in said aqueous continuous phase and having a second charge such that said second charge is opposite in sign to said first charge; and
(3) a block copolymer additive stably dispersed or dissolved in the vehicle, the block copolymer additive having a hydrophobic segment and a hydrophilic segment, the hydrophilic segment having one or more ionic groups the charge of which is the same in sign as the first charge.

14. The ink set of claim 13, wherein the oil phase of the first inkjet ink composition comprises an oil with a vapor pressure less than that of water.

15. The ink set of claim 14, wherein the oil is selected from the group consisting of monoethylene glycol phenyl ether, diethylene glycol phenyl ether, monopropylene glycol phenyl ether, dipropylene glycol phenyl ether and mixtures thereof.

16. The ink set of claim 13, wherein the oil phase of the first inkjet ink composition is present in a range of from about 1% to about 40% by weight based on the total weight of the ink composition.

17. The ink set of claim 13, wherein the vehicle of the first inkjet ink composition further comprises a co-emulsifier selected from C₃-C₈ alcohols.

18. The ink set of claim 17, wherein the co-emulsifier is present in an amount of from about 0.1% to about 20% by weight based on the total weight of the ink composition, and the molar ratio of emulsifier to co-emulsifier is about 1:8 or less.

19. The ink set of claim 13, wherein the colorant of the first inkjet ink composition is an anionic dye, and the emulsifier and block copolymer are cationic.

20. The ink set of claim 13, wherein the emulsifier of the first inkjet ink composition has the formula
[R(CH₃)₃N]⁺X⁻
wherein R is a C₆-C₃₀ alkyl, and X is an anionic counterion.

21. The ink set of claim 13, wherein the block copolymer of the first inkjet ink composition is an AB block copolymer comprising one hydrophobic segment and one hydrophilic segment.

22. The ink set of claim 13, wherein the hydrophilic segment of the block coplymer of the inkjet ink composition comprises about 10% to about 90% by weight based on the weight of the block copolymer.

23. The ink set of claim 13, wherein the molar ratio of ionic groups in the block co-polymer to ionic groups in the colorant in the first inkjet ink composition is in the range of from about 0.1 to about 1.5.

24. The ink set of claim 13, wherein the first inkjet ink composition has a surface tension in the range of about 20 dyne/cm to about 70 dyne/cm, and a viscosity of 30 cP or less, at 25° C.

25. The ink set of claim 13, comprising at least one cyan ink, at least one magenta ink and at least one yellow ink, with at least one of the inks being the first inkjet ink composition.

26. A method for ink jet printing onto a substrate, comprising the steps of:
(a) providing an ink jet printer that is responsive to digital data signals;
(b) loading the printer with a substrate to be printed;
(c) loading the printer with an ink; and
(d) printing onto the substrate using the ink in response to the digital data signals, wherein the ink is a first inkjet ink composition comprising:
(1) a vehicle comprising:
(a) an aqueous continuous phase,
(b) an oil phase emulsified in said aqueous continuous phase, and
(f) an ionic group-containing emulsifier to stabilize the emulsion of said oil phase in said aqueous phase, said ionic groups of said emulsifier having a first charge,
(2) a colorant soluble in said aqueous continuous phase and having a second charge such that said second charge is opposite in sign to said first charge; and
(3) a block copolymer additive stably dispersed or dissolved in the vehicle, the block copolymer additive having a hydrophobic segment and a hydrophilic segment, the hydrophilic segment having one or more ionic groups the charge of which is the same in sign as the first charge.

27. The method of claim 26, wherein the printer is loaded with an ink set comprising at least three differently colored inks, wherein at least one of the inks is the first inkjet ink composition, and wherein the substrate is printed using the ink set in response to the digital data signals.

28. The method of claim 27, wherein the ink set comprises at least one cyan ink, at least one magenta ink and at least one yellow ink, with at least one of the inks being the first inkjet ink composition.
